(19) United States
(12) Patent Application Publication
(10) Pub. No.: US 2003/0184522 A1
(43) Pub. Date: Oct. 2, 2003

(54) Text input device

(76) Inventor: Takashi Mita, Shizuoka (JP)

Correspondence Address: KANESAKA AND TAKEUCHI, 1423 Powhatan Street, Alexandria, VA, 22314, US

(21) Appl. No.: 10/107,337

(22) Filed: Mar. 28, 2002

(51) Int. Cl. G09G 5/00

(52) U.S. Cl. 345/169

(57) ABSTRACT

It is an object of the present invention to provide a text input device with excellent operability. The text input device is a text input device for causing a letter corresponding to a press of an operating portion to be displayed on a display by the press of the operating portion. The device includes a main body having a multifunction key switch actuated by operating the operating portion to tilt it in a plurality of directions and a plurality of letters provided to the main body and marked on an outside of the multifunction key switch and in the respective plurality of directions. The multifunction key switch is actuated and the letter corresponding to one direction is displayed on the display when the operating portion is tilted in the one direction of the plurality of directions.

### BACKGROUND OF THE INVENTION

1. Field of the Invention

The present invention relates to a text input device and a text input device with excellent operability.

2. Description of the Related Art

Conventionally, in personal-computer keyboard entry, an input key is assigned to a letter and a letter can be entered by a press of a key.

In this case, however, a key layout, i.e., which key in which position corresponds to which letter, needs to be grasped, which is difficult.

On the other hand, a text entry method currently in common use in many cellular phones is excellent in that an input key corresponds to several letters. Therefore, there are few keys and it is easy to find a correspondence between a position of a key and a letter.

However, the method cannot be said to be convenient in that a key needs to be pressed again and again to enter a letter.

For example, according to the entry method used in currently major cellular phones, for enter of a kana “e”, after pressing a key for a row starting with “a” four times such that “a ”, “i”, “u”, and then “e” are displayed, an ENTER key needs to be pressed. This is true not only in entry of Japanese kana but also in entry of English alphabets and characters of other languages.

### SUMMARY OF THE INVENTION

The present invention has been accomplished with the above circumstances in view and it is an object of the invention to provide a text input device with excellent operability.

### BRIEF DESCRIPTION OF THE DRAWINGS

FIG. 1 is a schematic partial plan view of a text input device of an embodiment of the present invention applied to a keyboard.

FIG. 2 is a schematic partial enlarged plan view showing an enlarged view of a part of FIG. 1.

FIG. 3 is a schematic perspective view of FIG. 2.

FIG. 4 is a schematic partial enlarged plan view of another embodiment different from the embodiment in FIG. 2.

FIG. 5 is a schematic plan view of the text input device of the invention applied to a cellular phone.

FIG. 6 is a schematic partial enlarged plan view showing an enlarged view of a part of FIG. 5.

### EXPLANATION OF REFERENCE NUMERALS

A text input device

1 multifunction key switch

2 letter

10 main body

11 operating portion

### DETAILED DESCRIPTION OF THE PREFERRED EMBODIMENTS

A text input device according to an embodiment of the present invention will be described below based on the drawings.

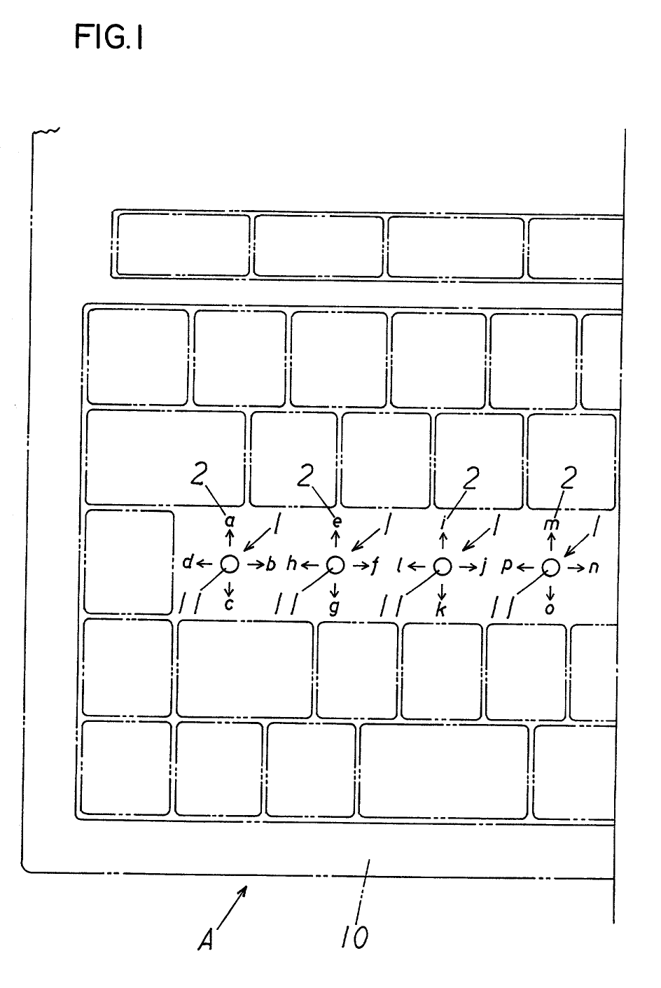

In FIG. 1, a reference numeral A designates the text input device (e.g., a keyboard). By a press (operation) of an operating portion 11 (e.g., a lever 11 in FIG. 3) in the text input device A, a letter corresponding to the press of the operating portion 11 is displayed on a display (display portion).

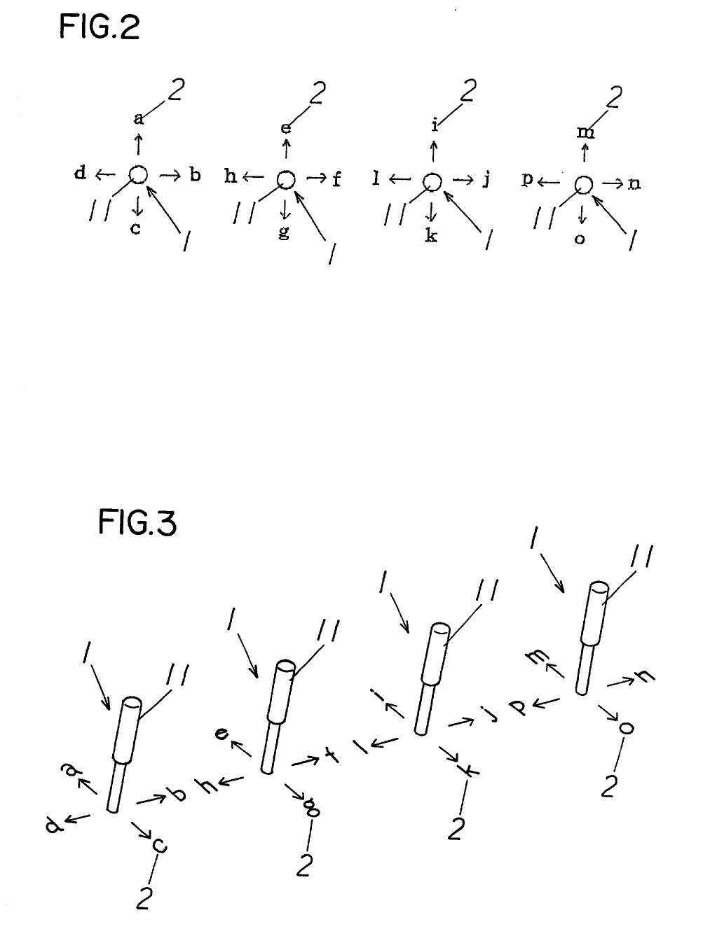

A reference numeral 10 designates a main body including multifunction key switches 1 each of which is actuated by operating the operating portion 11 to tilt it in a plurality of directions. The multifunction key switch 1 is a lever switch, for example, and a movable contact member (not shown) is moved by pressing a stick-shaped lever 11 (pushing it down in directions of arrows in FIGS. 1 and 2) to turn a switch (not shown) on and to input a signal corresponding to the direction of the push.

In other words, if the operating portion 11 is tilted in one of the plurality of directions, the multifunction key switch 1 is actuated and the letter corresponding to the one direction is displayed on the display (not shown).

For example, on the display (not shown), a letter “a” is displayed when the operating portion 11 is tilted in a direction of a, a letter “b” is displayed when the operating portion 11 is tilted in a direction of b, a letter “c” is displayed when the operating portion 11 is tilted in a direction of c, and a letter “d” is displayed when the operating portion 11 is tilted in a direction of d.

The multifunction key switch 1 is not limited to the lever switch but may be “a multifunction key switch device (10), a multifunction key switch device (53)” disclosed in Japanese Patent Application Laid-open No. 2000-22794 or “a multidirectional switch” disclosed in Japanese Patent Application Laid-open No. 2000-353456, for example, which operates when the operating portion is operated by tilting in a plurality of directions without using the lever.

A plurality of letters 2 are marked on the main body 10 in the respective plurality of directions on an outside of the multifunction key switch 1.

The marked plurality of letters 2 are alphabets. The plurality of direction are at least four directions including front, back, left, and right and four alphabets are marked in alphabetical order in the respective plurality of directions.

Layouts of the four alphabets in the alphabetical order are “a, b, c, d”, “e, f , g, h”, “i, j, k, l”, “m, n , o, p”, . . . , for example, as shown in FIGS. 1 and 2.

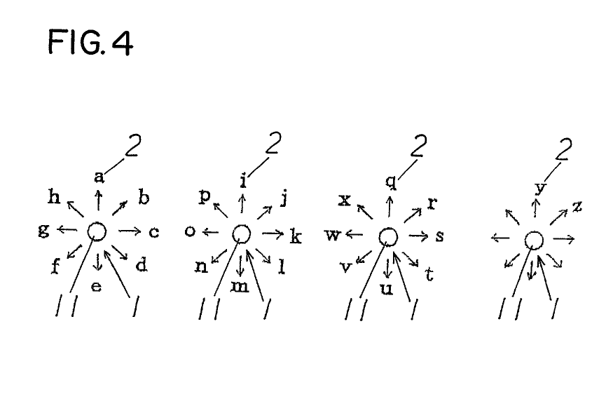

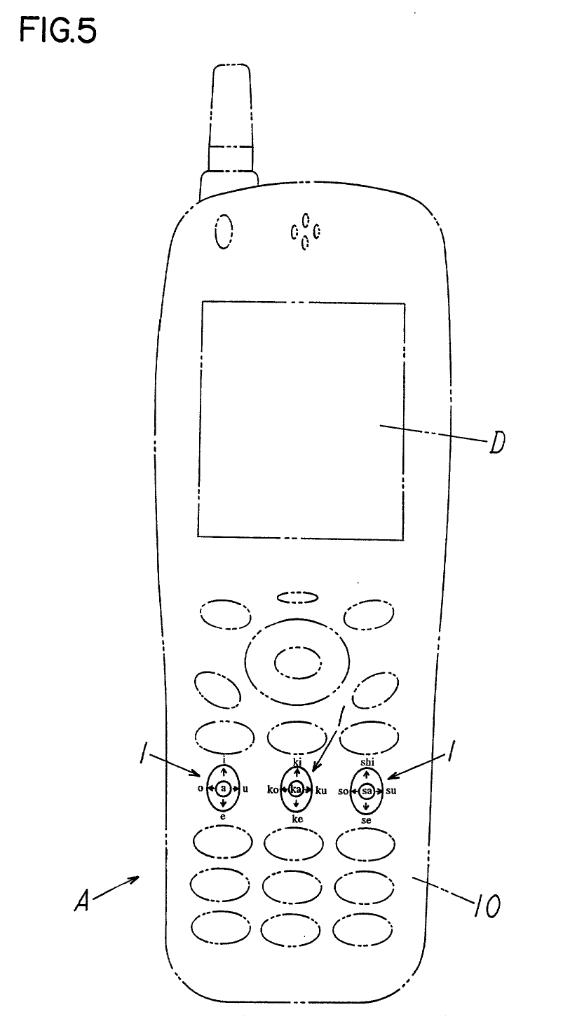

Although the plurality of directions are four directions including front, back, left, and right and the plurality of letters 2 are the four alphabets marked in the alphabetical order in the respective plurality of directions in the above-described embodiment, the invention is not limited to the embodiment. For example, as shown in FIG. 4, it is possible that diagonal directions are further added to the directions shown in FIG. 2 and that eight alphabets are marked in the alphabetical order in the respective diagonal directions (“a, b, c, d, e, f, g, h”, “i, j, k, l, m, n, o, p”, “q, r, s, t, u, v, w, x”). In short, in the invention, the plurality of directions may be at least four directions including front, back, left, and right and four alphabets may be marked in the alphabetical order in the respective plurality of directions.

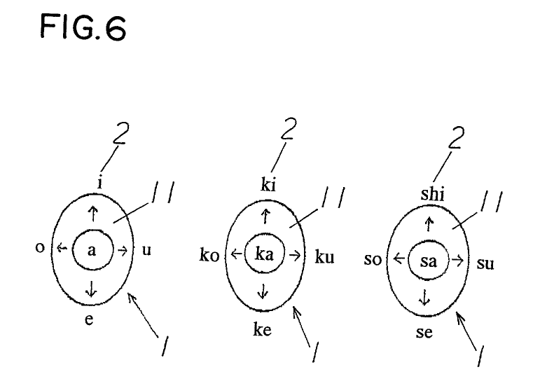

Next, an example in which the text input device 1 is applied to a cellular phone will be described (see FIGS. 5 and 6).

In the text input device A shown in FIGS. 5 and 6, similarly to the above description, a letter corresponding to a press of the operating portion 11 is displayed on a display D by the press (operation) of the operating portion 11.

A reference numeral 10 designates a main body including multifunction key switches 1 each of which is actuated by operating the operating portion 11 to tilt it in a plurality of directions. The multifunction key switch 1 operates when the operating portion 11 is operated by tilting (including 0°) in a plurality of directions and may be “a multifunction key switch device (10), a multifunction key switch device (53)” disclosed in Japanese Patent Application Laid-open No. 2000-22794 or “a multidirectional switch” disclosed in Japanese Patent Application Laid-open No. 2000-353456, for example.

The plurality of directions of the multifunction key switch 1 are five directions including a vertical direction (a direction perpendicular to the operating portion 11) at a central portion of the multifunction key switch 1 and four directions of front, back, left, and right with respect to the central portion. A first Japanese phonetic character of any one of “a row starting with a”, “a row starting with ka”, and “a row starting with sa” which are Japanese phonetic characters is marked on a surface of the central portion of the operating portion 11 of the multifunction key switch 1. For example, as shown in FIGS. 5 and 6, “a”, “ka”, and “sa” are marked on surfaces of the central portions of the operating portions 11.

Four characters in Japanese alphabetical order and following the first character (“a”, “ka”, or “sa”) which is the Japanese phonetic character marked on the surface of the central portion are marked in the respective four directions and on an outside of the operating portion 11 of the multifunction key switch 1 provided to the main body 10. In other words, as shown in FIGS. 5 and 6, if “a” is marked on the surface of the central portion of the operating portion 11, “i”, “u”, “e”, and “o” are marked in the respective four directions. If “ka” is marked on the surface of the central portion of the operating portion 11, “ki”, “ku”, “ke”, and “ko” are marked in the respective four directions. If “sa” is marked on the surface of the central portion of the operating portion 11, “shi”, “su”, “se”, and “so” are marked in the respective four directions.

Therefore, by pressing the operating portion 11 (pressing it in directions of arrows in FIGS. 5 and 6 or pressing “a”, “ka”, or “sa” shown in FIGS. 5 and 6 in vertical directions), the movable contact member (not shown) is moved to turn the switch (not shown) on and to input the signal corresponding to the direction of the press. If the operating portion 11 is tilted (including 0°) in a direction of “a”, the character “a” is displayed on the display D.

As a result, because the first Japanese phonetic character of any one of the row starting with a, the row starting with ka, and the row starting with sa is marked on the surface of the central portion of the operating portion 11 and four characters in Japanese alphabetical order and following the first character of the row starting with a, the row starting with ka, or the row starting with sa marked on the surface of the central portion are marked in the respective four directions and on an outside of the multifunction key switch 1, it is easier to grasp the layouts of the Japanese characters to be entered.

What is claimed is:

1. A text input device for causing a letter corresponding to a press of an operating portion to be displayed on a display by said press of said operating portion,
said device comprising a main body including a multifunction key switch actuated by operating said operating portion to tilt said operating portion in a plurality of directions
and a plurality of letters provided to said main body and marked on an outside of said multifunction key switch and in said respective plurality of directions,
wherein said multifunction key switch is actuated and said letter corresponding to one direction is displayed on said display when said operating portion is tilted in said one direction of said plurality of directions.

2. A text input device according to claim 1,
wherein said marked plurality of letters are alphabets,
said plurality of directions are at least four directions including front, back, left, and right, and
four of said alphabets are marked in alphabetical order in said respective plurality of directions.

3. A text input device according to claim 1,
wherein said plurality of directions of said multifunction key switch are five directions including a vertical direction of a central portion of said multifunction key switch and four directions of front, back, left, and right with respect to said central portion,
a first Japanese phonetic character of any one of “a row starting with a”, “a row starting with ka”, and “a row starting with sa” which are Japanese phonetic characters is marked on a surface of said central portion of said operating portion of said multifunction key switch, and
four characters following said first Japanese phonetic character which is said Japanese phonetic character marked on said surface of said central portion are marked in Japanese alphabetical order on an outside of said operating portion of said multifunction key switch and in said four directions.

4. A text input device according to claim 1,
wherein said multifunction key switch is a lever switch which is actuated by operating said lever switch to tilt said lever switch in a plurality of directions.
